(19) United States
(12) Patent Application Publication
(10) Pub. No.: US 2025/0174629 A1
(43) Pub. Date: May 29, 2025

(54) NEGATIVE ELECTRODE PLATE, ELECTROCHEMICAL APPARATUS, AND ELECTRONIC APPARATUS

(71) Applicant: Ningde Amperex Technology Limited, Ningde City (CN)

(72) Inventor: Baoxiao Cheng, Ningde City (CN)

(73) Assignee: Ningde Amperex Technology Limited, Ningde City (CN)

(21) Appl. No.: 18/956,510

(22) Filed: Nov. 22, 2024

(30) Foreign Application Priority Data
Nov. 23, 2023 (CN) 202311580392.9

(51) Int. Cl. H01M 4/133; H01M 4/02; H01M 4/13; H01M 4/136; H01M 4/48; H01M 4/58; H01M 4/587; H01M 4/62; H01M 10/0525

(52) U.S. Cl. CPC H01M 4/133; H01M 4/13; H01M 4/136; H01M 4/483; H01M 4/58; H01M 4/587; H01M 4/622; H01M 10/0525; H01M 2004/021; H01M 2004/027

(57) ABSTRACT

A negative electrode active material layer includes a first negative electrode active material layer and a second negative electrode active material layer. The second negative electrode active material layer is located between the current collector and the first negative electrode active material layer. The first negative electrode active material layer includes a first graphite material, and Dᵥ50 of the first graphite material is denoted as Dᵥ₁50, and 10 μm≤Dᵥ₁50≤16 μm. The second negative electrode active material layer includes a second graphite material and a silicon-based material, Dᵥ50 of the second graphite material is denoted as Dᵥ₂50, and 12 μm≤Dᵥ₂50≤30 μm, and Dᵥ50 of the silicon-based material is denoted as Dᵥ₃50, and 6 μm≤Dᵥ₃50≤10 μm.

### CROSS-REFERENCE TO RELATED APPLICATIONS

This application claims priority to Chinese Patent Application No. 202311580392.9, filed on Nov. 23, 2023, the whole disclosure of which is incorporated herein by reference.

### TECHNICAL FIELD

This application relates to the field of energy storage technologies, and in particular, to a negative electrode plate, and an electrochemical apparatus and electronic apparatus containing the negative electrode plate.

### BACKGROUND

Since a reversible capacity of silicon is as high as 4200 mAh/g, silicon-based negative electrode materials are considered to be one of effective strategies to improve energy density of lithium-ion batteries. However, in a charge and discharge process, when lithium ions are intercalated and deintercalated, volume swelling of silicon particles exceeds 100%, and large volume swelling destroys structural stability and integrity of electrode plates. In particular, large volume swelling damages solid electrolyte interphase (SEI). As a result, electrolyte penetrate into negative electrode plates, triggering a series of unstable reactions such as electrolyte decomposition and repeated SEI formation, and significantly reducing cycling performance of electrochemical apparatuses.

### SUMMARY

In view of the above problems in the prior art, this application proposes a negative electrode plate, and an electrochemical apparatus and electronic apparatus containing the same. The negative electrode plate is a silicon-containing structure with multiple active material layers, and can effectively solve the cycling swelling problem of electrochemical apparatuses.

According to a first aspect, this application provides a negative electrode plate including a current collector and negative electrode active material layers disposed on two opposite surfaces of the current collector, where each negative electrode active material layer includes a first negative electrode active material layer and a second negative electrode active material layer, and the second negative electrode active material layer is located between the current collector and the first negative electrode active material layer; where the first negative electrode active material layer includes a first graphite material, and Dᵥ50 of the first graphite material is denoted as Dᵥ₁50, satisfying 10 μm≤Dᵥ₁50≤16 μm, and the second negative electrode active material layer includes a second graphite material and a silicon-based material, Dᵥ50 of the second graphite material is denoted as Dᵥ₂50, satisfying 12 μm≤Dᵥ₂50≤30 μm, and Dᵥ50 of the silicon-based material is denoted as Dᵥ₃50, satisfying 6 μm≤Dᵥ₃50≤10 μm. In this application, pores formed by the second graphite material are filled with the silicon-based material with a small particle size, particle size distribution of the first graphite material, the second graphite material, and the silicon-based material is reasonably controlled, and graphite is used to bind the silicon-based material so as to mitigate displacement caused by silicon swelling. This effectively solves the cycling swelling problem of silicon-containing negative electrode plates and increases the cycling capacity retention rate of electrochemical apparatuses. Additionally, the silicon-based material with a small particle size adsorbs a binder, and pores formed by graphite particles are filled with the silicon-based material adsorbed with the binder with a small particle size, offering better adhesion, enhancing the adhesion force of electrode plates, and maintaining excellent cycling performance of electrochemical apparatuses.

Further, in some embodiments, Dᵥ₂50 of the second graphite material is larger than Dᵥ₁50 of the first graphite material, and a particle size of the second graphite material satisfies 25 μm≤Dᵥ₂50≤30 μm, further alleviating the cycling swelling of the silicon-containing negative electrode plate.

In some embodiments, an OI value (orientation index) of the first graphite material ranges from 5 to 15. A smaller OI value means better Li⁺ diffusion, helping to alleviate the cycling swelling and improve the kinetic performance. Further, the OI value (orientation index) of the first graphite material ranges from 5 to 11.

In some embodiments, 0.29≤Dᵥ₃50/Dᵥ₂50≤0.80. Within this particle size ratio range, the second graphite material and the silicon-based material are tightly stacked so that the silicon-based material can better fill the pores formed by the second graphite material, resulting in low electrode plate porosity, strong binding effect on silicon, and effectively mitigating displacement caused by silicon swelling.

In some embodiments, 0.29≤Dᵥ₃50/Dᵥ₂50≤0.45. In this particle size ratio range, the second graphite material is most closely stacked with the silicon-based material so that the electrode plate porosity is smaller, offering a better binding effect on silicon and further alleviating the cycling swelling problem.

In some embodiments, based on mass of the second negative electrode active material layer, a mass percentage of the silicon-based material is M, satisfying 0<M≤15%. A too high silicon percentage leads to a too high swelling rate, resulting in cycling deterioration.

In some embodiments, the silicon-based material is selected from at least one of silicon, silicon-oxygen compound, silicon-carbon compound, or silicon alloy. In some embodiments, the silicon-based material is preferably a silicon-oxygen compound or silicon-carbon compound.

In some embodiments, a ratio of coating weight surface density of the first negative electrode active material layer and the second negative electrode active material layer is X, satisfying 1.5≤X≤4. In this ratio range, the coating weight surface density of the first negative electrode active material layer containing no silicon is greater than that of the second negative electrode active material layer containing silicon, which is conducive to alleviating the swelling of the negative electrode plate.

In some embodiments, the first negative electrode active material layer further includes a first binder, and the second negative electrode active material layer further includes a second binder.

The first binder and/or the second binder includes but is not limited to at least one of polyamide, polyacrylonitrile, acrylate polymer, polyacrylic acid, polyacrylate, sodium carboxymethyl cellulose, polyvinyl pyrrolidone, polyvinyl ether or styrene-butadiene rubber.

In some embodiments, the first binder is preferably styrene-butadiene rubber.

In some embodiments, the second binder is preferably polyacrylic acid.

In some embodiments, the first negative electrode active material layer and/or the second negative electrode active material layer further includes a conductive agent. In some embodiments, any conductive material can be used for the conductive agent provided that it does not cause chemical changes. In some embodiments, the conductive agent includes at least one of conductive carbon black, acetylene black, carbon nanotubes, ketjen black, carbon fiber, or graphene. In some embodiments, the conductive agent is preferably conductive carbon black.

In some embodiments, the negative electrode current collector may be copper foil, nickel foil, stainless steel foil, titanium foil, nickel foam, copper foam, a polymer substrate coated with a conductive metal, or a combination thereof. In some embodiments, the negative electrode current collector is preferably a copper foil.

In some embodiments, total porosity of the negative electrode plate is A, satisfying 15%≤A≤30%.

According to a second aspect, this application provides an electrochemical apparatus, and the electrochemical apparatus includes a positive electrode plate, a separator, an electrolyte, and the negative electrode plate according to the first aspect.

According to a third aspect, this application provides an electronic apparatus including the electrochemical apparatus according to the second aspect.

Beneficial effects are as follows:

This application proposes the silicon-containing negative electrode plate, which includes the first negative electrode active material layer and the second negative electrode active material layer. The second negative electrode active material layer is located between the current collector and the first negative electrode active material layer. In this application, pores formed by graphite particles in the second negative electrode active material layer are filled with the silicon-based material with a small particle size, particle size distribution of the graphite particles and the silicon-based material of the two active material layers is reasonably controlled, and graphite is used to bind the silicon-based material so as to mitigate displacement caused by silicon swelling. This effectively solves the cycling swelling problem of silicon-containing negative electrode plates and increases the cycling capacity retention rate of electrochemical apparatuses. Additionally, the silicon-based material with a small particle size adsorbs a binder, and pores formed by graphite particles are filled with the silicon-based material adsorbed with the binder with a small particle size, offering better adhesion, enhancing the adhesion force of electrode plates, and maintaining excellent cycling performance of electrochemical apparatuses.

### BRIEF DESCRIPTION OF DRAWINGS

FIG. 1 is a schematic cross-sectional view of a negative electrode plate according to Example 1 of this application.

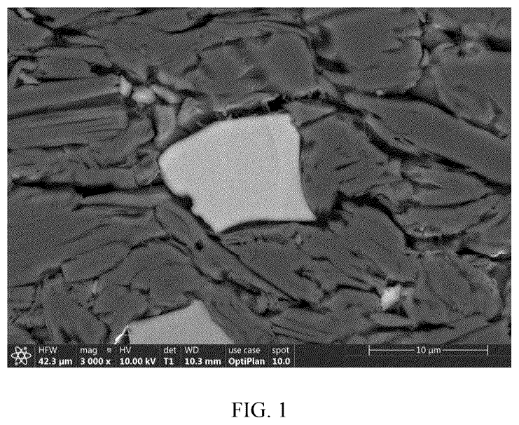

### DETAILED DESCRIPTION

To make the objectives, technical solutions, and advantages of this application clearer, the following clearly and completely describes the technical solutions in this application with reference to the embodiments. Apparently, the described embodiments are some but not all of the embodiments of this application. The embodiments described herein are illustrative and used to provide a basic understanding of this application. The embodiments of this application should not be construed as a limitation on this application.

For brevity, this specification specifically discloses only some numerical ranges. However, any lower limit may be combined with any upper limit to form a range not expressly recorded; any lower limit may be combined with any other lower limit to form a range not expressly recorded; and any upper limit may be combined with any other upper limit to form a range not expressly recorded. In addition, each individually disclosed point or individual single in numerical value may itself be a lower limit or an upper limit which ca be combined with any other point or individual numerical value or combined with another lower limit or upper limit to form a range not expressly recorded.

In the descriptions of this specification, “more than” or “less than” is inclusive of the present number unless otherwise specified.

Unless otherwise specified, the terms used in this application have well known meanings as commonly understood by persons skilled in the art. Unless otherwise specified, numerical values of parameters mentioned in this application may be measured by using various measurement methods commonly used in the art (for example, they may be tested by using the methods provided in the embodiments of this application).

In the specific embodiments and claims, an item list connected by the terms “at least one of”, “at least one piece of”, “at least one kind of” or other similar terms may mean any combination of the listed items. For example, if items A and B are listed, the phrase “at least one of A and B” means only A; only B; or A and B. In another example, if items A, B, and C are listed, the phrase “at least one of A, B, or C” means only A; only B; only C; A and B (exclusive of C); A and C (exclusive of B); B and C (exclusive of A); or all of A, B, and C. The item A may contain a single element or a plurality of elements. The item B may contain a single element or a plurality of elements. The item C may contain a single element or a plurality of elements.

In the description of this specification, it should be furthered noted that the terms “first”, “second”, and the like are merely intended for distinctive description, and shall not be understood as an indication or implication of relative importance.

According to a first aspect, this application provides a negative electrode plate including a current collector and negative electrode active material layers disposed on two opposite surfaces of the current collector, where each negative electrode active material layer includes a first negative electrode active material layer and a second negative electrode active material layer, and the second negative electrode active material layer is located between the current collector and the first negative electrode active material layer; where the first negative electrode active material layer includes a first graphite material, and Dᵥ50 of the first graphite material is denoted as Dᵥ₁50, satisfying 10 μm≤Dᵥ₁50≤16 μm, and the second negative electrode active material layer includes a second graphite material and a silicon-based material, Dᵥ50 of the second graphite material is denoted as Dᵥ₂50, satisfying 12 μm≤Dᵥ₂50≤30 μm, and Dᵥ50 of the silicon-based material is denoted as Dᵥ₃50, satisfying 6 μm≤Dᵥ₃50≤10 μm.

In this application, pores formed by the second graphite material are filled with the silicon-based material with a small particle size, particle size distribution of the first graphite material, the second graphite material, and the silicon-based material is reasonably controlled, and graphite is used to bind the silicon-based material so as to mitigate displacement caused by silicon swelling. This effectively solves the cycling swelling problem of silicon-containing negative electrode plates and increases the cycling capacity retention rate of electrochemical apparatuses. Additionally, the silicon-based material with a small particle size adsorbs a binder, and pores formed by graphite particles are filled with silicon-based material adsorbed with the binder with a small particle size, offering better adhesion, enhancing the adhesion force of electrode plates, and maintaining excellent cycling performance of electrochemical apparatuses.

In some embodiments, Dᵥ₁50 can be 10 μm, 11 μm, 12 μm, 13 μm, 14 μm, 15 μm, 16 μm, or in a range defined by any two of these values. In some embodiments, Dᵥ₂50 can be 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, or in a range defined by any two of these values. In some embodiments, Dᵥ₃50 can be 6 μm, 7 μm, 8 μm, 9 μm, 10 μm, or in a range defined by any two of these values.

In some embodiments, an OI value (orientation index) of the first graphite material ranges from 5 to 15. A smaller OI value means better Li⁺ diffusion, helping to alleviate the cycling swelling and improve the kinetic performance. In some embodiments, the OI value can be 8, 8.5, 9, 10, 11, 12, 12.5, 13, 15, or in a range defined by any two of these values.

In some embodiments, 0.29≤Dᵥ₃50/Dᵥ₂50≤0.80. In some embodiments, Dᵥ₃50/Dᵥ₂50 can be 0.29, 0.3, 0.35, 0.4, 0.45, 0.5, 0.55, 0.6, 0.65, 0.7, 0.75, or 0.8, or in a range defined by any two of these values. Within this particle size ratio range, the second graphite material and the silicon-based material are tightly stacked so that the silicon-based material can better fill the pores formed by the second graphite material, resulting in low electrode plate porosity, strong binding effect on silicon, and effectively mitigating displacement caused by silicon swelling.

In some embodiments, 0.29≤Dᵥ₃50/Dᵥ₂50≤0.45. In some embodiments, Dᵥ₃50/Dᵥ₂50 can be 0.29, 0.3, 0.32, 0.33, 0.35, 0.37, 0.38, 0.4, 0.42, 0.43, or 0.45, or in a range defined by any two of these values. In this particle size ratio range, the second graphite material is most closely stacked with the silicon-based material so that the electrode plate porosity is smaller, offering a better binding effect on silicon and further alleviating the cycling swelling problem.

In some embodiments, based on mass of the second negative electrode active material layer, a mass percentage of the silicon-based material is M, satisfying 0<M≤15%. In some embodiments, M can be 0.1%, 0.5%, 1%, 2%, 4%, 6%, 8%, 10%, 12%, 14%, 15%, or in a range defined by any two of these values. A too high silicon percentage leads to a too high swelling rate, resulting in cycling deterioration.

In some embodiments, the silicon-based material is selected from at least one of silicon, silicon-oxygen compound, silicon-carbon compound, or silicon alloy. In some embodiments, the silicon-based material is preferably a silicon-oxygen compound or silicon-carbon compound.

In some embodiments, a ratio of coating weight surface density of the first negative electrode active material layer and the second negative electrode active material layer is X, satisfying 1.5≤X≤4. In some embodiments, X can be 1.5, 2, 2.5, 3, 3.5, 4, or in a range defined by any two of these values. In this ratio range, the coating weight surface density of the first negative electrode active material layer containing no silicon is greater than that of the second negative electrode active material layer containing silicon, which is conducive to reducing the swelling rate of the negative electrode plate.

In some embodiments, the first negative electrode active material layer further includes a first binder, and the second negative electrode active material layer further includes a second binder.

The first binder and/or the second binder includes but is not limited to at least one of polyamide, polyacrylonitrile, acrylate polymer, polyacrylic acid, polyacrylate, sodium carboxymethyl cellulose, polyvinyl pyrrolidone, polyvinyl ether or styrene-butadiene rubber.

In some embodiments, the first binder is preferably styrene-butadiene rubber.

In some embodiments, the second binder is preferably polyacrylic acid.

In some embodiments, the first negative electrode active material layer and/or the second negative electrode active material layer further includes a conductive agent. In some embodiments, any conductive material can be used for the conductive agent provided that it does not cause chemical changes. In some embodiments, the conductive agent includes at least one of conductive carbon black, acetylene black, carbon nanotubes, ketjen black, carbon fiber, or graphene. In some embodiments, the conductive agent is preferably conductive carbon black.

In some embodiments, the negative electrode current collector may be copper foil, nickel foil, stainless steel foil, titanium foil, nickel foam, copper foam, a polymer substrate coated with a conductive metal, or a combination thereof. In some embodiments, the negative electrode current collector is preferably a copper foil.

In some embodiments, total porosity of the negative electrode plate is A, satisfying 15%≤A≤30%. In some embodiments, A can be 15%, 16%, 18%, 20%, 22%, 24%, 26%, 28%, 30%, or in a range defined by any two of these values.

According to a second aspect, this application provides an electrochemical apparatus, and the electrochemical apparatus includes a positive electrode plate, a separator, an electrolyte, and the negative electrode plate according to the first aspect.

In some embodiments, the positive electrode plate includes a positive electrode active material layer and a positive electrode current collector.

In some embodiments, the positive electrode active material layer includes a positive electrode active material. In some embodiments, the positive electrode active material includes at least one of ternary nickel-cobalt material and phosphate material. In some embodiments, the ternary nickel-cobalt material includes at least one of LiNiₓCo_{y}M_{(1-x-y)}O₂ materials, where M includes at least one of manganese, aluminum, magnesium, chromium, calcium, zirconium, molybdenum, silver, or niobium, 0.5≤x≤1, 0≤y≤0.5, and x+y≤1. In some embodiments, the phosphate material includes at least one of LiMnₖB₍₁₋ₖ₎PO₄, where 0≤k≤1, and the element B includes at least one of iron, cobalt, magnesium, calcium, zinc, chromium, or lead. In some preferred embodiments, the positive electrode active material is selected from ternary nickel-cobalt materials. In some embodiments, the positive electrode active material may have a coating on its surface, or may be mixed with another compound having a coating. In some embodiments, the coating may include at least one compound of a coating element selected from oxide of the coating element, hydroxide of the coating element, oxyhydroxide of the coating element, oxycarbonates (oxycarbonate) of the coating element, and hydroxycarbonate (hydroxycarbonate) of the coating element. The compound used for the coating may be amorphous or crystalline. The coating element contained in the coating may include Mg, Al, Co, K, Na, Ca, Si, Ti, V, Sn, Ge, Ga, B, As, or Zr, or a combination thereof. The coating can be applied by using any method as long as the method does not adversely affect performance of the positive electrode active material. For example, the method may include any coating method well known to a person of ordinary skill in the art, such as spraying or dipping. In some embodiments, the positive electrode active material is preferably lithium cobalt oxide.

In some embodiments, the positive electrode active material layer further includes a conductive agent and a binder. In some embodiments, the binder includes but is not limited to polyvinyl alcohol, hydroxypropyl cellulose, diacetyl cellulose, polyvinyl chloride, carboxylated polyvinyl chloride, polyvinylpyrrolidone, polyurethane, polytetrafluoroethylene, polyvinylidene fluoride, styrene-butadiene rubber, or acrylate styrene-butadiene rubber. In some embodiments, the conductive agent includes but is not limited to carbon-based materials, metal-based materials, conductive polymers, and a mixture thereof. In some embodiments, the carbon-based material is selected from graphite, carbon black, acetylene black, Ketjen black, carbon nanotubes, carbon fiber, graphene, or any combination thereof. In some embodiments, the metal-based material is selected from metal powder, metal fiber, copper, nickel, aluminum, or silver. In some embodiments, the conductive polymer is a polyphenylene derivative.

In some embodiments, the positive electrode plate further includes a positive electrode current collector, and the positive electrode current collector can be a metal foil or a composite current collector. For example, an aluminum foil may be used. The composite current collector may be formed by forming a metal material (copper, copper alloy, nickel, nickel alloy, titanium, titanium alloy, silver, silver alloy, or the like) on a polymer matrix.

In some embodiments, the electrolyte includes a lithium salt and a non-aqueous solvent.

In some embodiments, the lithium salt is selected from one or more of LiPF₆, LiBF₄, LiAsF₆, LiCIO₄, LiB(C₆H₅)₄, LiCH₃SO₃, LiCF₃SO₃, LiN(SO₂CF₃)₂, LiC(SO₂CF₃)₃, LiSiF₆, LiBOB, or lithium difluoroborate. For example, the lithium salt may be LiPF₆.

In some embodiments, the non-aqueous solvent may be a carbonate compound, a carboxylate compound, an ether compound, another organic solvent, or a combination thereof.

The carbonate compound may be a linear carbonate compound, a cyclic carbonate compound, a fluorocarbonate compound, or a combination thereof.

An example of the linear carbonate compound is dimethyl carbonate (DMC), diethyl carbonate (DEC), dipropyl carbonate (DPC), methyl propyl carbonate (MPC), ethylene propyl carbonate (EPC), methyl ethyl carbonate (MEC), or a combination thereof. An example of the cyclic carbonate compound is ethylene carbonate (EC), propylene carbonate (PC), butylene carbonate (BC), vinyl ethylene carbonate (VEC), or a combination thereof. An example of the fluorocarbonate compound is fluoroethylene carbonate (FEC), 4,5-difluoro-1,3-dioxolan-2-one, 4,4-difluoro-1,3-dioxolan-2-one, 4,4,5-trifluoro-1,3-dioxolan-2-one, 4,4,5,5-tetrafluoro-1,3-dioxolan-2-one, 4-fluoro-5-methyl-1,3-dioxolan-2-one, 4-fluoro-4-methyl-1,3-dioxolan-2-one, 4,5-difluoro-4-methyl-1,3-dioxolan-2-one, 4,4,5-trifluoro-5-methyl-1,3-dioxolan-2-one, 4-trifluoroMethyl ethylence carbonate, or a combination thereof.

An example of the carboxylate compound is methyl formate, methyl acetate, ethyl acetate, n-propyl acetate, tert-butyl acetate, methyl propionate, ethyl propionate, propyl propionate, γ-butyrolactone, decanolide, valerolactone, mevalonolactone, caprolactone, or a combination thereof.

An example of the ether compound is dibutyl ether, tetraglyme, diglyme, 1,2-dimethoxyethane, 1,2-diethoxyethane, ethoxymethoxy ethane, 2-methyltetrahydrofuran, tetrahydrofuran, and a combination thereof.

An example of the another organic solvent is dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate ester, and a combination thereof.

The electrolyte further includes an additive, which can be any additive that can be used for lithium-ion secondary batteries. It is not specifically limited in the present invention can be selected depending on actual needs. For example, the additive can be one or more of vinylene carbonate (VC), vinyl ethylene carbonate (VEC), succinonitrile (SN), adiponitrile (ADN), 1,3-propane sultone (PST), tris(trimethylsilyl)phosphate (TMSP), trimethyl borate (TMB), or tris(trimethylsilyl)borate (TMSB).

According to some embodiments of this application, in the electrochemical apparatus, a separator is provided between the positive electrode and the negative electrode to prevent short circuits. A material and shape of the separator used in the embodiments of this application are not specifically limited, and any technology disclosed in the prior art may be used for the separator. In some embodiments, the separator includes a polymer or an inorganic substance formed by a material stable to the electrolyte of this application. For example, the separator may include a substrate layer and a surface treatment layer. The substrate layer is a non-woven fabric, film, or composite film of a porous structure. The substrate layer is made of at least one of polyethylene, polypropylene, polyethylene terephthalate, or polyimide. Specifically, a polypropylene porous film, a polyethylene porous film, polypropylene non-woven fabric, polyethylene non-woven fabric, or a polypropylene-polyethylene-polypropylene porous composite film may be selected. The surface treatment layer is provided on at least one surface of the substrate layer, and the surface treatment layer may be a polymer layer or an inorganic substance layer, or may be a layer formed by a mixed polymer and an inorganic substance. The inorganic substance layer includes an inorganic particle and a binder. The inorganic particle includes at least one of aluminum oxide, silicon oxide, magnesium oxide, titanium oxide, hafnium oxide, tin oxide, ceria oxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder includes at least one of polyvinylidene fluoride, a vinylidene fluoride-hexafluoropropylene copolymer, polyamide, polyacrylonitrile, polyacrylic ester, polyacrylic acid, polyacrylate, polyvinylpyrrolidone, polyvinyl ether, polymethyl methacrylate, polytetrafluoroethylene, or polyhexafluoropropylene. The polymer layer contains a polymer, and a material of the polymer includes at least one of polyamide, polyacrylonitrile, acrylate polymer, polyacrylic acid, polyacrylate, polyvinylpyrrolidone, polyvinyl ether, polyvinylidene fluoride, or poly(vinylidene fluoride-hexafluoropropylene).

According to some embodiments of this application, the electrochemical apparatus of this application includes but is not limited to all types of primary batteries or secondary batteries. In some embodiments, the electrochemical apparatus is a lithium secondary battery. In some embodiments, the lithium secondary battery includes but is not limited to a lithium metal secondary battery, a lithium-ion secondary battery, a lithium polymer secondary battery or a lithium-ion polymer secondary battery.

According to a third aspect, the electronic apparatus in this application may be any apparatus using the electrochemical apparatus according to the second aspect of this application.

In some embodiments, the electronic apparatus includes but is not limited to notebook computers, pen-input computers, mobile computers, electronic book players, portable telephones, portable fax machines, portable copiers, portable printers, stereo headsets, video recorders, liquid crystal display televisions, portable cleaners, portable CD players, mini-disc players, transceivers, electronic notebooks, calculators, storage cards, portable recorders, radios, backup power sources, motors, automobiles, motorcycles, motor bicycles, bicycles, lighting appliances, toys, game machines, clocks, electric tools, flash lamps, cameras, large household batteries, lithium-ion capacitors, or the like.

### EXAMPLES AND COMPARATIVE EXAMPLES

Below, this application is further specifically described with examples and comparative examples, and this application is not limited to these examples as long as they do not depart from the essence of this application.

### Preparation of Lithium-Ion Pouch Battery

### Example 1

### (1) Preparation of Negative Electrode Plate

Upper slurry: A negative electrode active material of first graphite material (C), a binder styrene-butadiene rubber (SBR), and sodium carboxymethyl cellulose (CMC) were mixed at a mass ratio of 97.5:1.5:1, and dissolved in deionized water to form a negative electrode slurry with a solid content of 50%. The slurry was stirred to uniformity for later coating. Dᵥ₁50 of the first graphite material was 16 μm.

Lower slurry: A negative electrode active material of second graphite material (C), a silicon-based material, conductive carbon black, a binder polyacrylic acid (PAA), and sodium carboxymethyl cellulose (CMC) were mixed at a mass ratio of 86:10:0.5:3:0.5, and dissolved in deionized water to form a negative electrode slurry with a solid content of 40%. The slurry was stirred to uniformity for later coating. Dᵥ₂50 of the second graphite material was 12.5 μm, Dᵥ₃50 of the silicon-based material was 8.8 μm, and Dᵥ₃50/Dᵥ₂50=0.7.

Preparation of negative electrode plate with two layers of coatings: A double-layer coating machine was used to uniformly apply the upper negative electrode slurry and the lower negative electrode slurry onto one surface of a negative electrode current collector copper foil with a thickness of 10 μm, with a coating weight (surface density) ratio of 1:1 for the upper layer and lower layer. Coating weight surface density of both the upper and lower negative electrode slurries were 40 mg/1540.25 mm², and drying was performed at 110° C. to obtain a negative electrode plate with two negative electrode active material layers applied on one surface at a coating thickness of 150 μm. Then, the foregoing coating steps were repeated on another surface of the negative electrode plate to obtain a negative electrode plate coated with two negative electrode active material layers on two surfaces. After coating was completed, the negative electrode plate was dried, cold pressed, and cut into pieces of a size of 74 mm×867 mm for later use. Compacted density of the negative electrode plate was 1.7 g/cm³. Total porosity A of the negative electrode plate was 20%.

### (2) Preparation of Positive Electrode Plate

A positive electrode active material lithium cobalt oxide (LiCoO₂), a conductive agent carbon black (Super P), and a binder polyvinylidene fluoride (PVDF) were dissolved in a solvent N-methylpyrrolidone (NMP) at a mass ratio of 97:1.4:1.6 to form a positive electrode slurry with a solid content of 75%, and the slurry was stirred to uniformity. The positive electrode slurry was uniformly applied onto one surface of a positive electrode current collector aluminum foil with a thickness of 10 μm and dried at 110° C. to obtain a positive electrode plate having a positive electrode active material layer applied on one surface, with a coating of 110 μm in thickness. Then, the foregoing coating steps were repeated on another surface of the positive electrode plate so as to obtain a positive electrode plate with two surfaces coated with the positive electrode active material. After coating was completed, the positive electrode plate was dried, cold pressed, and cut into pieces of a size of 74 mm×867 mm for later use. Compacted density of the positive electrode plate was 4.15 g/cm³.

### (3) Preparation of Electrolyte

In an environment with a moisture content of less than 10 ppm, lithium hexafluorophosphate (LiPF₆) and a non-aqueous organic solvent were prepared into a base electrolyte. Organic solvents ethylene carbonate (EC):propylene carbonate (PC):diethyl carbonate (DEC):ethyl propionate (EP) were mixed at a mass ratio of 3:1:3:3, and then lithium hexafluorophosphate (LiPF₆) was added to the organic solvents to dissolve it. The foregoing substances were mixed to uniformity, with a concentration of LiPF₆ being 1 mol/L.

### (4) Preparation of Separator

A separator included a substrate layer and coatings. The substrate layer was 15 μm thick polyethylene (PE), and 2 μm aluminum oxide ceramic layers were applied on two sides of the substrate layer. Finally, 2.5 mg binder of polyvinylidene fluoride (PVDF) was applied on each side that was coated with the ceramic layer, and drying was performed.

### (5) Preparation of Lithium-Ion Battery

The positive electrode plate, the separator, and the negative electrode plate prepared above were stacked in order, so that the separator was sandwiched between the positive electrode plate and the negative electrode plate for separation. The stack was wound to obtain an electrode assembly. The electrode assembly was placed in an outer package aluminum-plastic film, and dried in a vacuum oven at 85° C. for 12 hours to remove water. The prepared electrolyte was injected, and vacuum packaging, standing, formation (charged to 3.5 V at 0.02C constantly, and charged to 3.9 V at 0.1C constantly), shaping, capacity test, and other processes were performed to obtain a lithium-ion battery.

### Examples 2 to 17

For the preparation method of lithium-ion batteries provided in Examples 2 to 17, reference can be made to Example 1. The differences were as follows:

The following data was selectively adjusted: type of the silicon-based material, Dᵥ₃50 of the silicon-based material, mass percentage of the silicon-based material in the second active material layer, Dᵥ₁50 of the first graphite material, Dᵥ₂50 of the second graphite material, particle size ratio of the silicon-based material to the second graphite material (Dᵥ₃50/Dᵥ₂50), OI value of the first graphite material, and ratio of coating weight surface density of the first negative electrode active material layer and the second negative electrode active material layer (coating weight ratio of the first and second negative electrode active material layers). Specific data and test data are shown in Table 1.

### Comparative Examples 1 to 7

For the preparation method of lithium-ion batteries provided in Comparative Examples 1 to 7, reference can be made to Examples 1 to 17. The differences were as follows:

The following was selectively adjusted: mass percentage of the silicon-based material in the second active material layer, Dᵥ₁50 of the first graphite material, Dᵥ₂50 of the second graphite material, Dᵥ₃50 of the silicon-based material, particle size ratio of the silicon-based material to the second graphite material (Dᵥ₃50/Dᵥ₂50), OI value of the first graphite material, ratio of coating weight surface density of the first negative electrode active material layer and the second negative electrode active material layer (coating weight ratio of the first and second negative electrode active material layers), and coating manner (one layer or two layers). Specific data and test data are shown in Table 1.

### Test Method

### 1. Test for Dᵥ50 of Materials

The laser diffraction method was used to test samples by using a MasterSizer2000 laser particle size analyzer to obtain Dᵥ50 of each material.

Sample amount: No less than 5 g of sample powder was taken, and a small beaker was used. An appropriate amount of the sample under test (about 0.02 g) and a few drops of 1% surfactant NP-40 were added into the beaker. The beaker was gently shaken to allow the surfactant to wet the sample. About 20 ml of water was added to fully disperse the powder in the water, and the substances were ultrasonically stirred for 5 minutes to uniformity before sampling.

### 2. Adhesion Force Test

The negative electrode plate was placed in a 60° C. oven to dry it for 15 hours, and then cut into strips of 1.5 cm*10 cm, so as to perform a 180° peel test. The specific test steps were as follows:

A double-sided tape was used to attach the cut electrode plate to a 3 cm*15 cm steel plate. The electrode plate was rolled with a small stick for 7 or 8 times. The peel test was performed using a tensile machine, with the steel plate in the lower fixture and the electrode plate in the upper fixture. The sample was stretched by 50 mm at a constant speed of 50 mm/min, to obtain stress and displacement data.

### 3. Porosity Determining

The porosity of the electrode plate was tested with a true density analyzer (AccuPyc II1340)

Analysis principle: Gas displacement method—the Archimedes' principle of gas displacement (density=mass/volume) and the Boyle's law of an inert gas with a small molecular diameter under certain conditions (PV=nRT) were used to accurately measure a true volume of the material under test to obtain the true density and porosity thereof.

Number of samples: It was required to punch the electrode plate into more than 40 circular disks with a diameter of 10 mm or 14 mm.

Result calculation: The test results can show the true volume V2 of the sample, the apparent volume V1 was equal to S*H*number of samples (S was the surface area of the sample, and H was the thickness of the electrode plate), and then the porosity of the sample was obtained by using the porosity=(V1−V2)/V1*100%.

### 4. Test for OI Value of Graphite Particles

XRD was used to test the OI value of the electrode plate containing the graphite material, where the size of the electrode plate sample was 1 cm*1 cm. OI value=C004/C100, where C004 represents the intensity (peak area) of the 004 peak, and C100 represents the intensity (peak area) of the 100 peak.

### 5. Cycling and Swelling Performance Test

The lithium-ion battery was left standing at 25° C. for 5 minutes, then charged to 4.45 V at 0.7C constantly, charged to 0.05C at a constant voltage of 4.45 V, and left standing for 5 minutes. A thickness of the battery measured at the position of the negative tab represented the thickness of the lithium-ion battery. Thicknesses at three points were measured, and an average value was denoted as MMC₀. Then, the lithium-ion battery was discharged to 3.0 V at 0.5C constantly, and left standing for 5 minutes. The discharge capacity of the first cycle was recorded. The above charge and discharge cycles was repeated for 200 cycles, and a discharge capacity after 200 cycles was recorded. Thicknesses of the lithium-ion battery at three points were measured, the average value MMC₂₀₀ was obtained, 200 charge and discharge cycles were performed, and a discharge capacity after 400 cycles was recorded.

$$Cycling capacity retention rate after 400 cycles = ( discharge capacity of the {400}^{th} \text{} cycle / discharge capacity of the first cycle ) \times 100 \%$$

$$Battery swelling rate after 200 cycles = ( {MMC}_{200} - {MMC}_{0} ) / {MMC}_{0} \times 100 \%$$

TABLE 1

| | | | | | Mass | Ratio of | | | Coating | | | |
|---|---|---|---|---|---|---|---|---|---|---|---|---|
| | | | | | percentage | particle sizes | | | weight | | | |
| | | | | | of silicon- | of silicon- | | | ratio | | | |
| | | | | | based | based | | | of first and | | | Cycling |
| | | | | Dᵥ₃50 | material in | material | OI | | second | | Cycling | capacity |
| | First | Second | | of | second | and second | value | | negative | Total | swelling | retention |
| | graphite | graphite | | silicon- | active | graphite | of | One- | electrode | porosity | rate | rate a |
| | material | material | Type of | based | material | material | first | layer or | active | of | after | fter |
| | Dᵥ₁50 | Dᵥ₂50 | silicon-based | material | layer | (Dᵥ₃50/ | graphite | two-layer | material | electrode | 200 | 400 |
| Examples | (μm) | (μm) | material | (μm) | (%) | Dᵥ₂50) | material | coating | layers | plate | cycles | cycles |
| Example 1 | 16 | 12.5 | Silicon-carbon | 8.8 | 10 | 0.7 | 12 | Two layers | 1:1 | 20% | 7.3% | 92% |
| Example 2 | 16 | 12.5 | Silicon-carbon | 8.8 | 15 | 0.7 | 11 | Two layers | 7:4 | 30% | 7.1% | 91% |
| Example 3 | 12.5 | 12.5 | Silicon-carbon | 6 | 10 | 0.48 | 11 | Two layers | 1:1 | 25% | 7.3% | 90% |
| Example 4 | 12.5 | 12.5 | Silicon-carbon | 8.8 | 10 | 0.7 | 11 | Two layers | 1:1 | 27% | 7.2% | 90% |
| Example 5 | 12.5 | 12.5 | Silicon-carbon | 10 | 10 | 0.8 | 11 | Two layers | 1:1 | 27% | 7.4% | 92% |
| Example 6 | 12.5 | 15 | Silicon-carbon | 8.8 | 10 | 0.59 | 11 | Two layers | 1:1 | 24% | 7% | 89% |
| Example 7 | 12.5 | 25 | Silicon-carbon | 8.8 | 10 | 0.35 | 11 | Two layers | 1:1 | 21% | 6.8% | 93% |
| Example 8 | 12.5 | 30 | Silicon-carbon | 8.8 | 10 | 0.29 | 11 | Two layers | 1:1 | 22% | 6.8% | 94% |
| Example 9 | 12.5 | 15 | Silicon-oxygen | 8.8 | 10 | 0.59 | 5 | Two layers | 1:1 | 21% | 6.5% | 91% |
| Example 10 | 12.5 | 15 | Silicon-oxygen | 8.8 | 10 | 0.59 | 8 | Two layers | 1:1 | 23% | 6.9% | 93% |
| Example 11 | 12.5 | 15 | Silicon-oxygen | 8.8 | 10 | 0.59 | 15 | Two layers | 1:1 | 22% | 7.5% | 92% |
| Example 12 | 12.5 | 15 | Silicon-carbon | 8.8 | 10 | 0.59 | 12 | Two layers | 6:4 | 23% | 7.1% | 92% |
| Example 13 | 12.5 | 15 | Silicon-carbon | 8.8 | 10 | 0.59 | 12 | Two layers | 7:3 | 24% | 7% | 93% |
| Example 14 | 12.5 | 15 | Silicon-carbon | 8.8 | 10 | 0.59 | 12 | Two layers | 8:2 | 22% | 7.2% | 92% |
| Example 15 | 10 | 20 | Silicon-carbon | 8.8 | 10 | 0.44 | 11 | Two layers | 1:1 | 21% | 6.9% | 91% |
| Example 16 | 14 | 28 | Silicon-carbon | 8.8 | 10 | 0.31 | 11 | Two layers | 1:1 | 22% | 6.9% | 92% |
| Example 17 | 16 | 12.5 | Silicon-carbon | 8.8 | 20 | 0.7 | 12 | Two layers | 1:1 | 28% | 8.5% | 90% |
| Comparative | / | 12.5 | Silicon-carbon | 8.8 | 10 | 0.7 | 10 | One layer | | 28% | 8.7% | 88% |
| Example 1 | | | | | | | | | | | | |
| Comparative | 16 | 6.6 | Silicon-carbon | 8.8 | 10 | 1.33 | 12 | Two layers | 1:1 | 32% | 7.6% | 88.5% |
| Example 2 | | | | | | | | | | | | |
| Comparative | 12.5 | 22 | Silicon-carbon | 5 | 10 | 0.23 | 12 | Two layers | 1:1 | 22% | 7.5% | 88% |
| Example 3 | | | | | | | | | | | | |
| Comparative | 12.5 | 25 | Silicon-carbon | 12 | 10 | 0.48 | 12 | Two layers | 1:1 | 24% | 7.6% | 87% |
| Example 4 | | | | | | | | | | | | |
| Comparative | 12.5 | 32 | Silicon-carbon | 10 | 10 | 0.31 | 12 | Two layers | 1:1 | 23% | 7.5% | 86% |
| Example 5 | | | | | | | | | | | | |
| Comparative | 19 | 12.5 | Silicon-carbon | 9.2 | 10 | 0.74 | 12 | Two layers | 1:1 | 29% | 7.6% | 85% |
| Example 6 | | | | | | | | | | | | |
| Comparative | 9 | 12.5 | Silicon-carbon | 8.8 | 10 | 0.7 | 11 | Two layers | 1:1 | 19% | 7.7% | 85% |
| Example 7 | | | | | | | | | | | | |

It can be seen from comparison of data in Examples 1 to 17 and Comparative Examples 1 to 7 in Table 1 that when the particle size distribution of the negative electrode active materials all satisfies the conditions of 10 μm≤Dᵥ₁50≤16 μm, 12 μm≤Dᵥ₂50≤30 μm, and 6 μm≤Dᵥ₃50≤10 μm, the cycling capacity retention rate after 400 cycles of the electrochemical apparatus is significantly increased, and the cycling swelling rate after 200 cycles is significantly reduced. Generally, the swelling data after 200 cycles of the electrochemical apparatus tested is sufficient to evaluate the swelling performance of the battery, so it is sufficient to demonstrate that the technical solution of this application can effectively solve the cycling swelling problem of silicon-containing negative electrode plates and maintain excellent cycling performance. The reason is that in the silicon-containing negative electrode plate including multiple active material layer structures proposed in this application, pores formed by graphite particles in the second negative electrode active material are filled with the silicon-based material with a small particle size, particle size distribution of the graphite particles and the silicon-based material of the two active material layers is reasonably controlled, and the graphite material is used to bind the silicon-based material so as to mitigate displacement caused by silicon swelling. This effectively solves the cycling swelling problem of silicon-containing negative electrode plates and increases the cycling capacity retention rate of electrochemical apparatuses. Additionally, the silicon-based material with a small particle size adsorbs a binder, and pores formed by graphite particles are filled with the silicon-based material adsorbed with the binder with a small particle size, offering better adhesion, enhancing the adhesion force of electrode plates, and maintaining excellent cycling performance of electrochemical apparatuses. It can be seen from the data of Comparative Examples 1 to 7 that when the negative electrode plate does not meet the conditions defined by this application, the cycling swelling problem of electrochemical apparatuses cannot be solved, and the cycling capacity retention rate is significantly reduced.

Although illustrative embodiments have been demonstrated and described, a person skilled in the art should understand that the foregoing embodiments are not to be construed as limiting this application, and that the embodiments may be changed, replaced, and modified without departing from the spirit, principle, and scope of this application.

What is claimed is:

1. A negative electrode plate, comprising: a current collector and negative electrode active material layers disposed on two opposite surfaces of the current collector, wherein each negative electrode active material layer comprises a first negative electrode active material layer and a second negative electrode active material layer, and the second negative electrode active material layer is located between the current collector and the first negative electrode active material layer; wherein
the first negative electrode active material layer comprises a first graphite material, and Dᵥ50 of the first graphite material is denoted as Dᵥ₁50, and 10 μm≤Dᵥ₁50≤16 μm, and
the second negative electrode active material layer comprises a second graphite material and a silicon-based material, Dᵥ50 of the second graphite material is denoted as Dᵥ₂50, 12 μm≤Dᵥ₂50≤ 30 μm, and Dᵥ50 of the silicon-based material is denoted as Dᵥ₃50, 6 μm≤Dᵥ₃50≤10 μm.

2. The negative electrode plate according to claim 1, wherein 25 μm≤Dᵥ₂50≤30 μm.

3. The negative electrode plate according to claim 1, wherein 0.29≤Dᵥ₃50/Dᵥ₂50≤0.80.

4. The negative electrode plate according to claim 1, wherein 0.29≤Dᵥ₃50/Dᵥ₂50≤0.45.

5. The negative electrode plate according to claim 1, wherein an OI value of the first graphite material ranges from 5 to 15.

6. The negative electrode plate according to claim 5, wherein the OI value of the first graphite material ranges from 5 to 11.

7. The negative electrode plate according to claim 1, wherein based on a mass of the second negative electrode active material layer, a mass percentage of the silicon-based material is M, and 0<M≤15%.

8. The negative electrode plate according to claim 1, wherein the silicon-based material is selected from at least one of silicon, silicon-oxygen compound, silicon-carbon compound, or silicon alloy.

9. The negative electrode plate according to claim 1, wherein a ratio of a coating weight surface density of the first negative electrode active material layer and a coating weight surface density of the second negative electrode active material layer is X, and 1.5≤X≤4.

10. The negative electrode plate according to claim 1, wherein the first negative electrode active material layer further comprises a first binder, and the second negative electrode active material layer further comprises a second binder; wherein
the first binder comprises styrene-butadiene rubber, and/or
the second binder comprises polyacrylic acid.

11. An electrochemical apparatus, comprising a positive electrode plate, a separator, an electrolyte, and the negative electrode plate according to claim 1.

12. The electrochemical apparatus according to claim 11, wherein 25 μm≤Dᵥ₂50≤30 μm.

13. The electrochemical apparatus according to claim 11, wherein 0.29≤Dᵥ₃50/Dᵥ₂50≤0.80.

14. The electrochemical apparatus according to claim 11, wherein 0.29≤Dᵥ₃50/Dᵥ₂50≤0.45.

15. The electrochemical apparatus according to claim 11, wherein an OI value of the first graphite material ranges from 5 to 15.

16. The electrochemical apparatus according to claim 15, wherein the OI value of the first graphite material ranges from 5 to 11.

17. The electrochemical apparatus according to claim 11, wherein based on a mass of the second negative electrode active material layer, a mass percentage of the silicon-based material is M, and 0<M≤15%.

18. The electrochemical apparatus according to claim 11, wherein the silicon-based material is selected from at least one of silicon, silicon-oxygen compound, silicon-carbon compound, or silicon alloy.

19. The electrochemical apparatus according to claim 11, wherein a ratio of a coating weight surface density of the first negative electrode active material layer and a coating weight surface density of the second negative electrode active material layer is X, and 1.5≤X≤4.

20. An electronic apparatus, comprising the electrochemical apparatus according to claim 11.
